(19) United States
(12) Patent Application Publication
(10) Pub. No.: US 2008/0132233 A1
(43) Pub. Date: Jun. 5, 2008

(54) Method for Operating Two Radio Communication Systems

(75) Inventors: Hui Li, Beijing (CN); Egon Schulz, Munchen (DE); Dan Yu, Beijing (CN)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, Munich (DE)

(21) Appl. No.: 10/577,668

(22) PCT Filed: Oct. 19, 2004
(86) PCT No.: PCT/EP2004/052579

§ 371 Date: Oct. 4, 2007

(30) Foreign Application Priority Data
Oct. 31, 2003 (DE) 103 50 890.2

(51) Int. Cl. H04Q 7/20

(52) U.S. Cl. 455/436

(57) ABSTRACT

In a case where the radio coverage of first and the second radio communication systems, each including a plurality of radio stations, overlaps at least partially, a message containing operating instructions for organization of communication within the second radio communication system is sent from the first radio communication system to at least some of the radio stations of the second radio communication system.

### CROSS REFERENCE TO RELATED APPLICATIONS

This application is based on and hereby claims priority to German Application No. 10350890.2 filed on Oct. 31, 2003, the contents of which are hereby incorporated by reference.

### BACKGROUND OF THE INVENTION

1. Field of the Invention

The invention relates to a method for operating two radio communication systems with at least partially overlapping radio coverage areas. The invention additionally relates to a device in a radio communication system for executing the method.

2. Description of the Related Art

In radio communication systems, information (e.g. voice, image information, video information, SMS (Short Message Service), MMS (Multimedia Messaging Service) or other data) is transmitted via a radio interface between sending and receiving radio stations using electromagnetic waves. The radio stations can be various user-side radio stations, radio access points or base stations depending on the specific design of the radio communication system. The electromagnetic waves are emitted using carrier frequencies within the frequency band provided for the particular system.

Radio communication systems may differ e.g. in respect of their radio access technology or transmission method, network operating systems and network protocols. Examples of radio communication systems are systems compliant with the GSM (Global System for Mobile Communications), GPRS (General Packet Radio Service), EDGE (Enhanced Data Rates for GSM Evolution), TSM (Time Division Synchronous Code Division Multiple Access), DECT (Digital European Cordless Telephony), IS95 (Interim Standard No. 95), cdma2000, UMTS (Universal Mobile Telecommunications System), IEEE 802.11 and Bluetooth standards, as well as fourth generation systems.

Radio communication systems are often implemented as cellular systems e.g. according to the GSM or UMTS standard with a network infrastructure that includes, e.g., base stations, equipment for monitoring and controlling the base stations and other network-side equipment. For the cellular GSM mobile radio system, frequencies of 900, 1800 and 1900 MHz are used. In addition to these supralocally organized, hierarchical cellular radio networks there exist wireless local area networks (WLANs) with a spatially much more limited radio coverage area. With a diameter of up to a few hundred meters, the cells covered by the WLAN radio access points (APs) are small compared to normal mobile radio cells. Examples of different standards for WLANs are HiperLAN, DECT, IEEE 802.11, Bluetooth and WATM. The unlicensed frequency range around 2.4 GHz is generally used for WLANs, the data transmission rates being up to 11 Mbit/s. Future WLANs can be operated in the 5 GHz range and achieve data rates of over 50 Mbit/s. The data rates available to WLAN users are therefore much higher than those provided by third generation mobile radio (e.g. UMTS).

In many WLANs, user-side radio stations can communicate directly with one another via one or more hops (multihop). They can additionally send and receive information via WLAN radio access points which are generally connected to other communication systems. A user-side radio station can be connected to a radio access point either directly or via hops with data forwarding via other radio stations.

Different radio communication systems may have locally overlapping radio coverage areas. A suitable user-side radio station can therefore communicate simultaneously or consecutively within a plurality of radio communication systems. If common radio resources are available to a plurality of radio communication systems, lack of coordination may result in unwanted interference or incomplete utilization of the available radio resources.

### SUMMARY OF THE INVENTION

An object of the invention is to identify a method for operating two radio communication systems, overlapping at least partially in respect of their radio coverage, which will enable communication within the two radio communication systems to be coordinated.

The method is used for operating a first and a second radio communication system, the second radio communication system including a plurality of radio stations. The radio coverage areas of the first and second radio communication system overlap at least partially. According to an aspect of the invention, a message is sent by the first radio communication system to at least some of the radio stations of the second radio communication system with instructions for organizing communication within the second radio communication system.

Using the message of the first radio communication system, at least one radio station of the second radio communication system is instructed to forward information contained in the message concerning the organization of communication within the second radio communication system to other radio stations of the second radio communication system, the instructions of the first radio communication system being able to be forwarded directly, in whole or in part, to other radio stations by the at least one radio stations of the second radio communication system. However, is also possible that, prior to transmission of the information by the at least one radio stations, the instructions are revised by the at least one radio stations. In particular, instructions relating to timing specifications are forwarded by the first radio communication system to radio stations of the second radio communication system. The radio communication systems can be radio communication systems of the same or also of a different kind. As described above, radio communication systems may differ e.g. in respect of their radio access technology or transmission method, network operating systems on network protocols. It is possible that the two radio communication systems of the invention are interconnected via a suitable interface. The first radio communication system of the invention can be, e.g., a cellular radio communication system and the second radio communication system can be a WLAN.

The messages with instructions for organizing communication are preferably sent to those radio stations of the second radio communication system that have a radio interface for communication within the first and a radio interface for communication within the second radio communication system. These radio stations can form part of both the first and the second radio communication system. The radio stations to which the first radio communication system sends the message can be selected by it according to particular criteria, the criteria generally depending on the type or content of the instructions.

The instructions relate to the organization of communication within the second radio communication system. Communication within the second radio communication system is taken to mean the transmitting or receiving of messages in the form of user and/or signaling information by radio stations of the second radio communication system, the transmissions taking place according to the particular design of the second radio communication system. Examples of this are the exchange of messages between radio stations of the second radio communication system and the transmitting/receiving by radio stations of the second radio communication system of messages to/from communications terminals of another communication system.

The transmission of the instructions by the first radio communication system indicates that the first radio communication system is competent to intervene significantly in the communication process within the second radio communication system. The second radio communication system accordingly follows the instructions issued. Advantageously, the instructions are sent repeatedly by the first radio communication system, in particular periodically, the content of the instructions possibly varying from transmission to transmission. The method described can also be applied to a plurality of radio communication systems, so that, for example, a first radio communication system sends instructions for organizing communication to a plurality of other radio communication systems.

In a further development of the invention, the instructions relate to timing requirements for communication within the second radio communication system, thereby enabling the first radio communication system, for example, to specify the setup of a time frame structure, or even particular ways of using time slots within the second radio communication system.

According to one embodiment of the invention, the instructions relate to at least one time slot for communication within the second radio communication system on the basis of a centrally controlled radio access method and at least one time slot for communication within the second radio communication system on the basis of a decentrally controlled radio access method. For example, the instructions can contain the timing of the time slots by directly specifying time instants or lengths or implicit information concerning the timing. When using a centrally controlled radio access method, communication takes place after the relevant radio station has been assigned resources by a central or functionally higher-order instance. In the case of a decentrally controlled radio access method, on the other hand, radio stations generally access radio resources on an equal basis, without a central or functionally higher-order instance needing to be involved in assigning radio resources. In addition, the use of the time slots can be specified by the instructions of the first radio communication system such that, for example, the time slot with the decentrally controlled radio access method shall allow all the radio stations of the second radio communication system to access the radio resources, whereas access to the radio resources of the time slot with a centrally controlled radio access method may only take place after allocation of these radio resources to radio stations selected by the first radio communication system.

In a further development of the invention, a time for transmitting the information concerning organization is communicated to the one or more radio stations by the message of the first radio communication system.

Preferably the information concerning the organization relates to the timing of at least one time slot for communication within the second radio communication system on the basis of a centrally controlled radio access method and/or the timing of at least one time slot for communication within the second radio communication system on the basis of a decentrally controlled radio access method. The timing can be characterized e.g. by the start time and end time or by the start time and length of the relevant time slot or by the start time and beginning of a subsequent time slot. It is possible for information to be sent via a plurality of time slots of one type, for example the next two time slots with a decentrally controlled radio access method can be announced whereby the types of information transmitted via the two time slots can be different from one another.

According to an advantageous embodiment of the invention, the information concerning the organization relates to the assignment to at least one radio station of the second radio communication system of radio resources of a time slot for communication within the second radio communication system on the basis of a centrally controlled radio access method. In particular, radio resources can be assigned to a subset of the radio stations of the second radio communication system communicated by the first radio communication system. Radio resources can also be assigned to the at least one radio station which emits the information regarding the information.

In a further development of the invention, the information concerning organization relates to at least one time for the future transmission of information concerning the organization of communication within the second radio communication system by at least one radio station of the second radio communication system and/or for the future transmission of a message with instructions concerning the organization of communication within the second radio communication system by the first radio communication system. This information does not therefore relate to communication possibly taking place subsequent to the transmission of the information within the second radio communication system, but relates to a longer term planning period.

On the basis of the instructions of the first radio communication system for the organization of communication within the second radio communication system, the time sequence is preferably as follows:
a time slot with transmission of information by at least one radio station of the second radio communication system concerning the organization of subsequent communication within the second radio communication system,
a time slot for communication within the second radio communication system on the basis of a decentrally controlled radio access method,
a time slot for communication within the second radio communication system on the basis of a centrally controlled radio access method.

These three time slots can essentially follow one another directly or if necessary guard periods can be inserted between the different time slots. Although the time slots preferably occur in the sequence described, a timing rearrangement between the time slots with the centrally and the decentrally controlled radio access method is also possible.

According to an embodiment of the invention, common frequency radio resources are available to the first and the second radio communication system. The sequence as follows:
the message of the first radio communication system with instructions for the organization of communication within the second radio communication system,
the three time slots of the second radio communication system for the transmission of information concerning the organization of communication of the basis of the decentrally controlled radio access method and communication on the basis of the centrally controlled radio access method,
a time slot for communication within the first radio communication system.

The frequency radio resources available to the first and the second radio communication system can coincide completely or overlap at least in part. The time slots specified follow one another essentially directly. The timing is preferably as stated, but rearrangements in the sequence are possible.

Advantageously a device of the first radio communication system creates the instructions depending on information concerning radio stations, such as the mobility and data processing capacity of radio stations, and/or depending on information concerning radio resources of the second radio communication system, such as the utilization factor of radio resources or channel busy time. This information is preferably transmitted by radio stations of the second radio communication system, directly or via suitable devices, to the first radio communication system where it can be stored in a memory. Information preferably exists which all the radio stations of the second radio communication system must send to the first radio communication system.

Via the message created by the device according to the invention, at least one radio station of the second radio communication network is instructed to forward information contained in the message concerning the organization of communication within the second radio communication system to other radio stations of the second radio communication system.

A device according to an aspect of the invention in a first communication system has a unit storing information concerning radio stations and/or radio resources of a second radio communication system including a plurality of radio stations. The device additionally has a unit creating a message with instructions for the organization of communication within the second radio communication system, a unit selecting a subset of the radio stations of the second radio communication system, and a unit transmitting the message to the subset of radio stations of the second radio communication system.

The device according to the invention can also be implemented by a plurality of physically separate devices interconnected by suitable interfaces.

In one embodiment of the invention, the instructions in the message created by the device according to the invention relate to timing specifications for communication within the second radio communication system and/or at least one time slot for communication within the second radio communication system on the basis of a centrally controlled radio access method and at least one time slot for communication within the second radio communication system on the basis of a decentrally controlled radio access method.

Via the message created by the device according to the invention, at least one radio station of the second radio communication system is advantageously instructed to send information concerning the organization of communication within the second radio communication system to other radio stations of the second radio communication system.

According to an embodiment of the invention, via the message created by the device according to the invention at least one radio station is informed of a time for transmitting the information concerning the organization.

The device according to the invention is particularly suitable for carrying out the method according to the invention, this also applying to the embodiments and further developments.

### BRIEF DESCRIPTION OF THE DRAWINGS

These and other objects and advantages of the present invention will become more apparent and more readily appreciated from the following description of an exemplary embodiment, taken in conjunction with the accompanying drawings of which:

FIG. 1 is a block diagram of a section of two radio communication systems,

FIG. 2 is a time frame diagram according to an aspect of the invention,

FIG. 3 is a block diagram of a base station according to an aspect of the invention.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

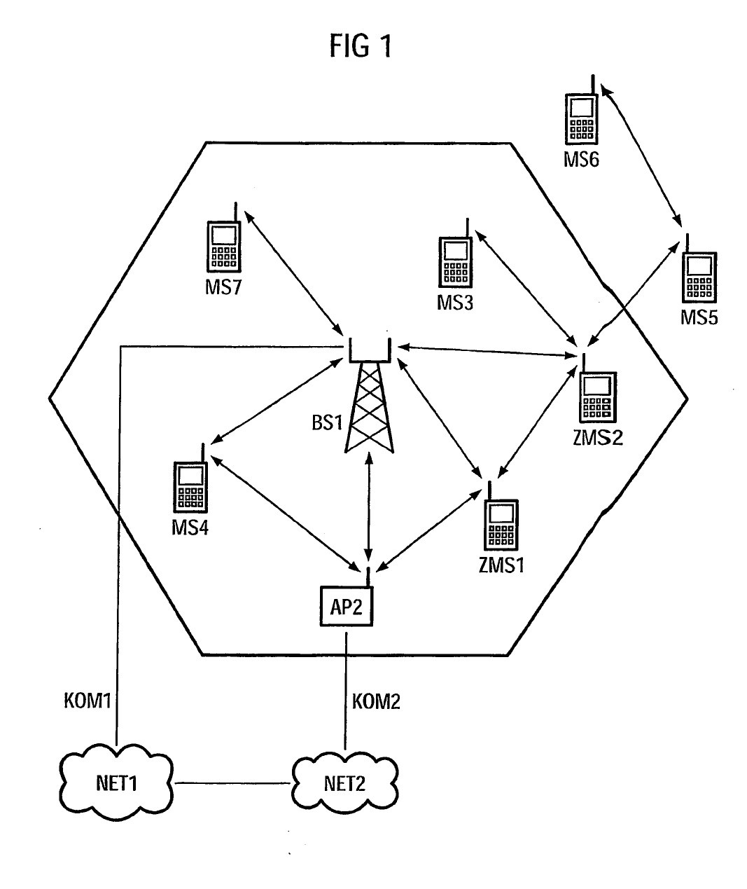

FIG. 1 shows a section of two radio communication systems KOM1 and KOM2. The first radio communication system KOM1 is a cellular system, a base station BS1 with its radio cell being illustrated. Other base stations of the generally area-wide radio communication system KOM1 with its radio cells are not shown in FIG. 1 for the sake of clarity. The base station BS1 is connected to other network-side devices NET1 of the first radio communication system KOM1. Another component of the first radio communication system KOM1 is a mobile station MS7. The second radio communication system KOM2 is a WLAN which has a radio access point AP2. This is connected to other network-side devices NET2 of the second radio communication system KOM2 which provides a link to other data and communication systems such as the radio communication system KOM1, for example. Another part of the second radio communication system KOM2 are the mobile stations ZMS1, ZMS2, MS3, MS4, MS5 and MS6.

The mobile stations ZMS1, ZMS2 and MS4 and the radio access point AP2 are equipped such that they can communicate both within the first radio communication system KOM1 and within the second radio communication system KOM2. The ability to communicate with the base station BS1 is symbolized by a double arrow between the mobile stations ZMS1, ZMS2 and MS4 or the radio access point AP2 and the base station BS1. The mobile stations ZMS1, ZMS2 and MS4 can therefore be part of the first and the second radio communication system KOM1 and KOM2 respectively. However, the two mobile stations MS3, MS5 and MS6 are unable, because of the design of their radio interfaces, to communicate with the base station BS1. The mobile station MS7, on the other hand, can only communicate within the first radio communication system KOM1.

Communication between the mobile stations ZMS1, ZMS2, MS3, MS4, MS5 and MS6 of the second radio communication system KOM2 or between the mobile stations ZMS1, ZMS2, MS3, MS4, MS5 and MS6 of the second radio communication system KOM2 and radio stations of other radio communication systems takes place via the radio access point AP2. The two mobile stations MS4 and ZMS1 are within the radio coverage area of the radio access point AP2 and can therefore communicate directly with same, which is symbolized in FIG. 1 by a double arrow between the radio access point AP2 and the mobile stations MS4 and ZMS1.

Mobile stations which are outside the radio coverage area of the radio access point AP2 require messages to be forwarded by other mobile stations in order to bridge the distance to the radio access point AP2. In order to increase the reliability of communication via hops within the second radio communication system KOM2, the base station BS1 defines a number of mobile stations of the second radio communication system KOM2 which therefore constitute a virtual core network of the second radio communication system KOM2. The mobile stations of the virtual core network are determined such that all or at least a large part of the communication between mobile stations outside the radio coverage area of the radio access point AP2 and the radio access point AP2 can be handled via the mobile stations of the virtual core network. The mobile stations of the virtual core network are exclusively mobile stations which can communicate within both radio communication systems KOM1 and KOM2. In the example in FIG. 1, the virtual core network includes the mobile stations ZMS1 and ZMS2.

The mobile stations of the virtual core network are selected according to such criteria as the mobility or hardware profile of mobile stations. For this purpose all the mobile stations which can communicate within both the first and the second radio communication system KOM1 and KOM2 transmit the information required for determining the virtual core network to the base station BS1.

The communication of the mobile station ZMS2 with the radio access point AP2 is conducted via the mobile station ZMS1, the communication of the mobile stations MS3 and MS5 via the mobile stations ZMS2 and ZMS1, and the communication of the mobile station MS6 with the radio access point AP2 via the mobile stations MS5, ZMS2 and ZMS1. The paths between the mobile stations ZMS2, MS3, MS5 and MS6 are symbolized by double arrows in each case.

It is assumed that a common frequency band is available to the two radio communication systems KOM1 and KOM2 for communication. This may result in interference between the communication of the mobile station MS7 with the base station BS1 and the communication of the mobile stations ZMS1, ZMS2, MS3, MS4, MS5 and MS6 with one another and with the access point AP2 when the common frequency band is used simultaneously by the two radio communication systems KOM1 and KOM2. In order to circumvent this, the base station BS1 sends a message to the second radio communication system KOM2 specifying the times at which the common radio resources may be used by the second radio communication system KOM2.

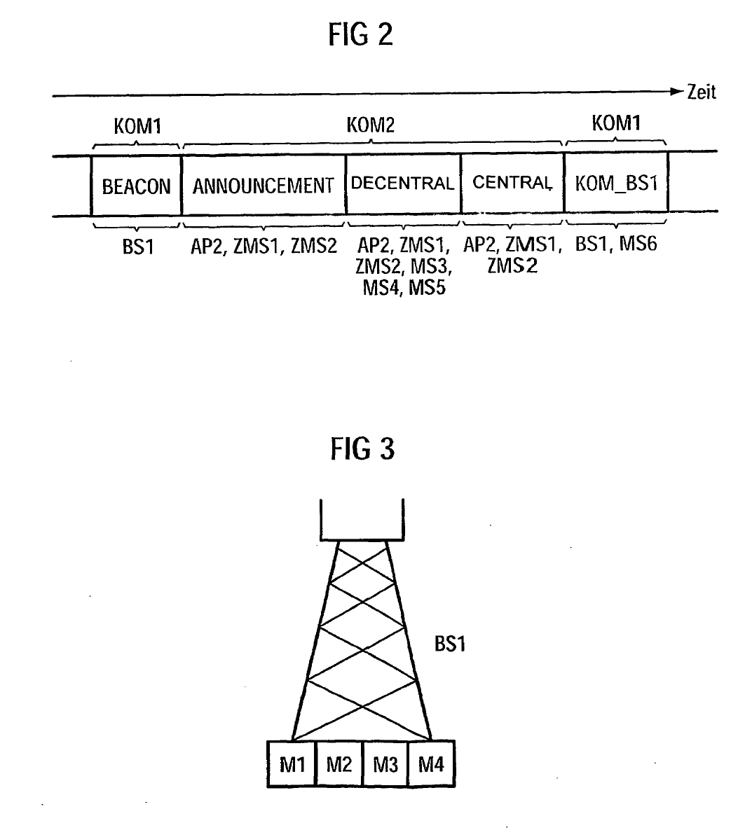

FIG. 2 shows the division of time into different time slots within which the radio resources common to the first and the second radio communication system KOM1 and KOM2 are used differently. A first time slot is used by the first radio communication system KOM1 in such a way that the base station BS1 sends out a BEACON message which is addressed to the radio access point AP2 and the mobile stations ZMS1 and ZMS2 of the virtual core network. The BEACON message is used to organize the following three time slots during which the radio resources are used by the second radio communication system KOM2.

In the BEACON message the radio access point AP2 and the mobile stations ZMS1 and ZMS2 are informed as to when they are to send out an ANNOUNCEMENT message, the communicated time possibly being different for the different radio stations sending out the ANNOUNCEMENT message. The earliest time specifies the start of a time phase during which the frequency band is available to the second radio communication system KOM2. The ANNOUNCEMENT message is then broadcast by the radio access point AP2 and by the mobile stations ZMS1 and ZMS2 at the time or times prescribed by the base station BS1 so that all the mobile stations within the radio coverage area of the radio access point AP2 and of the mobile stations ZMS1 and ZMS2 can receive and evaluate the ANNOUNCEMENT message. With the BEACON message is also possible for only some of the mobile stations ZMS1, ZMS2 of the virtual core network and of the radio access point AP2 to be requested to send the ANNOUNCEMENT message.

In addition, instructions concerning the content of the ANNOUNCEMENT message are issued to the radio access point AP2 and the mobile stations ZMS1 and ZMS2 with the BEACON message. In the ANNOUNCEMENT message, the timing of a DECENTRAL time slot, which is used for decentralized access to radio resources and subsequent communication, is notified to the mobile stations MS3, MS4, MS5 and MS6 of the second communication system KOM2. The timing can be specified e.g. by the start time and length of the time slot or by the start and end time. In the DECENTRAL time slot, the radio access point AP2 and the mobile stations ZMS1, ZMS2, MS3, MS4, MS5 and MS6 may access the radio resources decentrally. An example of decentralized utilization of radio resources is a CSMA (Carrier Sense Multiple Access) method as used in IEEE 802.11, or utilization of radio resources according to an R-ALOHA method. The radio stations which have succeeded in utilizing radio resources within a DECENTRAL time slot can use these radio resources for sending messages within the DECENTRAL time slot, any utilization of radio resources being strictly linked, however, with the end of the DECENTRAL time slot.

In addition, the ANNOUNCEMENT message can pass on information from the BEACON message to the mobile stations MS3, MS4, MS5 and MS6 which announces the time of the next transmission of a corresponding ANNOUNCEMENT message and the timing of a next DECENTRAL time slot. via this information, the mobile stations MS3, MS4, MS5 and MS6 can perform other tasks, such as changing over to power saving mode, in the periods in which they are neither listening to the ANNOUNCEMENT message nor communicating in a DECENTRAL time slot. The announcing of the next DECENTRAL time slot to the mobile stations MS3, MS4, MS5 and MS6 additionally facilitates synchronization to the next DECENTRAL time slot.

The DECENTRAL time slot is followed by the CENTRAL time slot during which the frequency band is available to the second radio communication system KOM2. In contrast to the DECENTRAL time slot, however, communication within the CENTRAL time slot only takes place after centralized assignment of radio resources. For this purpose the base station BS1 communicates, in the BEACON message, an assignment of radio resources of the CENTRAL time slot to the radio access point AP2 or to the mobile stations ZMS1 and ZMS2 of the virtual core network. Communication during the CENTRAL time slot is therefore only permitted to a subset of the radio stations of the second radio communication system KOM2. The communication of the radio access point AP2 or more specifically of the mobile stations ZMS1 and ZMS2 during the CENTRAL time slot using the radio resources allocated to them by the base station BS1 makes for efficient communication via hops within the second radio communication system KOM2. For example, information which the mobile station MS5 has previously sent to the mobile station ZMS2 during the DECENTRAL time slot can be forwarded to the radio access point AP2 in the CENTRAL time slot.

With the BEACON message, the base station BS1 can also instruct the mobile stations ZMS1 and ZMS2 as well as the radio access point AP2 to send, in the ANNOUNCEMENT message, information concerning the timing of the CENTRAL timeslot. This information then indicates to the mobile stations MS3, MS4 and MS5 the time interval in which they may not access the radio resources decentrally.

In addition to a CENTRAL time slot which is administered by the base station BS1, the use of a DECENTRAL timeslot for the communication of the mobile stations ZMS1, ZMS2, MS3, MS4, MS5 and MS6 of the second radio communication system KOM2 is useful, as the mobile stations MS3, MS5 and MS6 cannot communicate with the base station BS1, which means that the base station BS1 cannot directly obtain knowledge of the existence of the mobile stations. A decentralized radio access method therefore enables all the mobile stations ZMS1, ZMS2, MS3, MS4, MS5 and MS6 of the second radio communication system KOM2 to communicate with one another or with the radio access point AP2 without the base station BS1 being required to organize the communication. This increases communication flexibility within the second radio communication system KOM2.

During the DECENTRAL time slot, the mobile stations ZMS1, ZMS2, MS3, MS4, MS5 and MS6 monitor the radio channel and determine the time during which the radio channel in their vicinity is busy (channel busy time). During the transmission of messages by the mobile stations ZMS1, ZMS2, MS3, MS4, MS5 and MS6 to the radio access point AP2, the channel busy time thus determined is transmitted at the same time. This information is sent by the radio access point AP2 to the base station BS1 which can use a suitable average value of the busy times to determine the length of future DECENTRAL time slots. Due to the fact that the ratio of the lengths of the two time slots DECENTRAL and CENTRAL can vary with time, dynamic resource sharing between the two modes of the centralized and decentralized radio access method is implemented.

The mobile station MS6 cannot receive the ANNOUNCEMENT message sent out by the radio access point AP2 and by the mobile stations ZMS1 and ZMS2 as it is outside the radio coverage area of the mobile station ZMS2. The mobile station MS6 therefore has no knowledge of the timing of the DECENTRAL timeslot available to it for random accesses. It is therefore possible that the mobile station MS6 attempts, during the CENTRAL time slot, to utilize radio resources for sending a message to the mobile station MS5. However, as the mobile station MS5 has received and evaluated the ANNOUNCEMENT message, it does not respond to the call attempts of the mobile station MS6. No interference affecting message transmission during the CENTRAL time slot due to the call attempts of the mobile station MS6 takes place, as communication within the CENTRAL time slot is conducted exclusively by the radio access point AP2 and the mobile stations ZMS1 and ZMS2 which are outside the radio coverage area of the mobile station MS6. However, the mobile stations MS4, MS3 and MS5 which could interfere with communication during the CENTRAL time slot take the information in the ANNOUNCEMENT message into account and do not access radio resources during the CENTRAL time slot.

The sequence of the two time slots DECENTRAL and CENTRAL can be reversed. However, the advantage of the arrangement described is that, although the length of the DECENTRAL time slot is reduced by a potential lengthening of the ANNOUNCEMENT message, no modification of the allocation of radio resources effected by the CENTRAL time slot is required.

The end of the CENTRAL time slot is followed by a KOM_BS1 time slot during which the frequency band is available to the first radio communication system KOM1 so that communication between the base station BS1 and the mobile station MS7 can take place in the time slot KOM_BS1. The base station BS1 then retransmits a BEACON message with organization information for communication within the second radio communication system KOM2. The BEACON message is preferably transmitted periodically.

Whereas the method has been described for the case whereby communication between the mobile stations ZMS1, ZMS2, MS3, MS4, MS5 and MS6 of the second radio communication system KOM2 is via the radio access point AP2, the method is also applicable to an ad-hoc mode of the second radio communication system KOM2 in which the mobile stations ZMS1, ZMS2, MS3, MS4, MS5 and MS6 can communicate with one another directly without messages being forwarded via the radio access point AP2.

FIG. 3 shows the layout of the base station BS1. This has unit M1 storing information which it has received from the mobile stations or the radio access point of the second radio communication system. On the basis of this information, it uses the unit M2 to create a BEACON message. The unit M3 determines the mobile stations of the second radio communication system which constitute the virtual core network and are therefore recipients of the BEACON message. Another part of the base station BS1 is unit M4 for transmitting the BEACON message. The location of the units M1, M2, M3 and M4 in the base station BS1 is equivalent to outsourcing functionality to other devices connected to the base station BS1 directly or via other network-side devices.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-13. (canceled)

14. A method for operating first and second radio communication systems incorporating a plurality of radio stations and having radio coverage areas that overlap at least in part, comprising:
sending a message by the first radio communication system to at least some of the radio stations of the second radio communication system with instructions for organizing communication within the second radio communication system; and
instructing at least one radio station of the second radio communication system, via the message from the first radio communication system, to send information contained in the message concerning the organization of communication within the second radio communication system to other radio stations of the second radio communication system.

15. A method according to claim 14, wherein the instructions relate to timing specifications for communication within the second radio communication system.

16. A method according to claim 14, wherein the instructions relate to at least one period of time for communication within the second radio communication system based on a centrally controlled radio access method and at least one period of time for communication within the second radio communication system based on a decentrally controlled radio access method.

17. A method according to claim 14, wherein a time for sending the information concerning the organization is communicated to the at least one radio station via the message from the first radio communication system.

18. A method according to claim 14, wherein the information concerning the organization relates to at least one of the timing of at least one period of time for communication within the second radio communication system based on a centrally controlled radio access method and the timing of at least one period of time for communication within the second radio communication system based on a decentrally controlled radio access method.

19. A method according to claim 14, wherein the information concerning the organization relates to the assignment of radio resources of a period of time for communication within the second radio communication system based on a centrally controlled radio access method to at least one radio station of the second radio communication system.

20. A method according to claim 14, wherein the information concerning the organization relates to at least one time for at least one of future transmission of information concerning the organization of communication within the second radio communication system by at least one radio station of the second radio communication system and future transmission of a message with instructions concerning the organization of communication within the second radio communication system by the first radio communication system.

21. A method according to claim 14, wherein, based on the instructions of the first radio communication system for organizing communication within the second radio communication system, said method is performed in sequence as follows:
transmitting during a first period of time information by at least one radio station of the second radio communication system concerning the organization of subsequent communication within the second radio communication system;
communicating during a second period of time within the second radio communication system based on a decentrally controlled radio access method; and
communicating during a third period of time within the second radio communication system based on a centrally controlled radio access method.

22. A method according to claim 21,
wherein common frequency radio resources are available to the first and the second radio communication systems,
wherein the first period of time is preceded by sending the message of the first radio communication system with instructions for organizing communication within the second radio communication system, and
wherein the third period of time is followed by communicating within the first radio communication system during a fourth period of time.

23. A method according to claim 14, wherein a device of the first radio communication system creates the instructions depending on information about at least one of radio stations and radio resources of the second radio communication system.

24. A device in a first radio communication, comprising:
means for storing information about at least one of radio stations and radio resources of a second radio communication system having a plurality of radio stations;
means for creating a message with instructions for organizing communication within the second radio communication system, the message instructing at least one radio station of the second radio communication system to send information contained in the message concerning organization of communication within the second radio communication system to other radio stations of the second radio communication system;
means for selecting a subset of the radio stations of the second radio communication system; and
means for transmitting the message to the subset of radio stations of the second radio communication system.

25. A device according to claim 24, wherein the instructions in the message created by the device relate to at least one of timing specifications for communication within the second radio communication system, at least one period of time for communication within the second radio communication system based on a centrally controlled radio access method and at least one period of time for communication within the second radio communication system based on a decentrally controlled radio access method.

26. A device according to claim 25, wherein, via the message created by the device, a time for transmitting the information concerning the organization is communicated to the at least one radio station.
